(19) United States
(12) Patent Application Publication
(10) Pub. No.: US 2006/0251423 A1
(43) Pub. Date: Nov. 9, 2006

(54) Method and apparatus for identifying pump failures using an optical line interface

(76) Inventors: Stephen G. Evangelides JR., Red Bank, NJ (US); Jay P. Morreale, Summit, NJ (US); William David Cornwell, Chester (GB); Mark K. Young, Monmouth Junction, NJ (US); Jonathan A. Nagel, Brooklyn, NY (US); David S. DeVincentis, Flanders, NJ (US); Michael J. Neubelt, Little Silver, NJ (US)

Correspondence Address: MAYER & WILLIAMS PC, 251 NORTH AVENUE WEST, 2ND FLOOR, WESTFIELD, NJ, 07090, US

(21) Appl. No.: 11/125,298

(22) Filed: May 9, 2005

(51) Int. Cl. H04B 10/00

(52) U.S. Cl. 398/105

(57) ABSTRACT

An optical interface device is provided for use in an undersea optical transmission system that includes an undersea optical transmission path, a plurality of optical repeaters located along the optical transmission path, and a selected one of any of a plurality of different vendor supplied optical transmission terminals each of which has a vendor-specific interface. The optical interface device includes a signal processing unit providing signal conditioning to optical signals received from the vendor-specific interface of the selected optical transmission terminal so that the optical signals are suitable for transmission through the undersea optical transmission path. A gain monitoring arrangement is also provided for determining a change in gain provided by any one of the optical repeaters. The optical interface device also includes a processor for identifying a particular pump source that has failed from among a plurality of pump sources used to supply pump energy to the repeater based on the change in gain determined by the gain monitoring arrangement.

### STATEMENT OF RELATED APPLICATIONS

This application is related to co-pending U.S. patent application Ser. No. 10/621,028, filed Jul. 16, 2003, entitled “Method And Apparatus For Providing A Terminal Independent Interface Between A Terrestrial Optical Terminal And An Undersea Optical Transmission Path.”

This application is also related to co-pending U.S. patent application Ser. No. 10/621,115, filed Jul. 16, 2003, entitled “Method And Apparatus For Performing System Monitoring In A Terminal Independent Interface Located Between A Terrestrial Optical Terminal And An Undersea Optical Transmission System.”

This application is also related to co-pending U.S. patent application Ser. No. 10/417,657, filed Apr. 18, 2003, entitled “Method And Apparatus For Distributing Pump Energy To An Optical Amplifier Array In An Asymmetric Manner.”

This application is also related to co-pending U.S. patent application Ser. No. 11/031,518, filed Jan. 7, 2005, entitled “Method And Apparatus For Obtaining Status Information Concerning Optical Amplifiers For Obtaining Status Information Concerning Optical Amplifiers Located Along An Undersea Optical Transmission Line Using COTDR.”

This application is also related to co-pending U.S. patent application Ser. No. 11/031,517, filed Jan. 7, 2005, entitled “Method And Apparatus For In-Service Monitoring Of A Regional Undersea Optical Transmission System Using COTDR.”

Each of the above-referenced applications are incorporated by reference herein in their entireties.

### FIELD OF THE INVENTION

The present invention relates generally to optical transmission systems, and more particularly to the use of an arrangement to allow coherent optical time domain reflectometry (COTDR) to be used to identify pump failures that may arise in the repeaters employed in the optical transmission system.

### BACKGROUND OF THE INVENTION

A typical long-range optical transmission system includes a pair of unidirectional optical fibers that support optical signals traveling in opposite directions. Since the optical signals are attenuated over long distances, the optical transmission line will typically include repeaters that restore the signal power lost due to fiber attenuation and which are spaced along the transmission line at some appropriate distance from one another. The repeaters include optical amplifiers. The repeaters also include an optical isolator that limits the propagation of the optical signal to a single direction.

In long-range optical transmission links it is important to monitor the health of the system. For example, monitoring can detect faults or breaks in the fiber optic cable, localized increases in attenuation due to sharp bends in the cable, or the degradation of an optical component. Amplifier performance should also be monitored. For long haul undersea cables there are two basic approaches to in-service monitoring: monitoring that is performed by the repeaters, with the results being sent to the transmission terminal via a telemetry channel, and shore-based monitoring in which a special signal is sent down the line and is received and analyzed for performance data.

Coherent optical time domain reflectometry (COTDR) is one shore-based technique used to remotely detect faults in optical transmission systems. In COTDR, an optical probe pulse is launched into an optical fiber and backscattered signals returning to the launch end are monitored. In the event that there are discontinuities such as faults or splices in the fiber, the amount of backscattering generally changes and such change is detected in the monitored signals. Backscattering and reflection also occur from discrete elements such as couplers, which create a unique signature. The link's health or performance is determined by comparing the monitored COTDR with a reference record. New peaks and other changes in the monitored signal level being indicative of changes in the fiber path, normally indicating a fault.

One type of highly specialized optical transmission network in which COTDR techniques may be employed is an undersea or submarine optical transmission system in which a cable containing optical fibers is installed on the ocean floor. The repeaters are located along the cable, which contain the optical amplifiers that provide amplification to the optical signals to overcome fiber loss.

In a submarine optical transmission system, the design of the land-based terminals (the “dry-plant”) and the undersea cable and repeaters (the “wet plant”) are typically customized on a system-by-system basis and employ highly specialized terminals to transmit data over the undersea optical transmission path. For this reason the wet and dry plants are typically provided by a single entity that serves as a systems integrator. As a result all the elements of the undersea system can be highly integrated to function together. For example, all the elements can exchange information and commands in order to monitor service quality, detect faults, and locate faulty equipment. In this way the quality of service from end to end (i.e., from one land-based terminal to another) can be guaranteed. Moreover, since there is a single systems integrator involved, the system operator always knows who to contact in the event of a failure.

Recently, undersea optical transmission systems have been proposed in which the wet plant can be designed independently of the dry plant. Specifically, the wet plant is designed as an independent, stand-alone network element and is transparent to the dry plant. In this way the wet plant can accommodate a wide variety of different land-based terminals. In order to achieve such universal transparency, an optical interface device is provided between the wet plant and the terminals. The dry plant, including the optical interface device, is generally located in a cable station that is situated near the shore. Examples of such optical interface devices are shown in U.S. patent application Ser. Nos. 10/621,028 and 10/621,115.

Since the dry plant is to be transparent to the wet plant, the optical interface device should be capable of identifying faults that may arise in the various components of the wet plant. For example, one component of particular concern is the laser pump employed in the optical amplifiers for supplying pump power. Since the laser pump is the only active component in the repeater, it is the most likely to degrade or fail. Such failure would render the optical amplifier, and possibly the optical communication system, inoperative. To limit the impact of a laser pump failure, two or more pumps are often shared among two or more optical amplifiers that are located in the same repeater. In this way if one of the pumps fails, the remaining pump or pumps continue to provide power to each of the optical amplifiers, albeit at a reduced energy level. However, as long as some pump energy reaches each optical amplifier, there will be sufficient gain to convey the signals to the next repeater along the wet plant.

Accordingly, it would be desirable to provide an optical interface device operating between the wet plant and dry plant of an undersea optical communication system, which device is capable of identifying, from among multiple laser pumps used in a repeater, a particular laser pump that has failed.

### SUMMARY OF THE INVENTION

In accordance with the present invention, an optical interface device is provided for use in an undersea optical transmission system that includes an undersea optical transmission path, a plurality of optical repeaters located along the optical transmission path, and a selected one of any of a plurality of different vendor supplied optical transmission terminals each of which has a vendor-specific interface. The optical interface device includes a signal processing unit providing signal conditioning to optical signals received from the vendor-specific interface of the selected optical transmission terminal so that the optical signals are suitable for transmission through the undersea optical transmission path. A gain monitoring arrangement is also provided for determining a change in gain provided by any one of the optical repeaters. The optical interface device also includes a processor for identifying a particular pump source that has failed from among a plurality of pump sources used to supply pump energy to the repeater based on the change in gain determined by the gain monitoring arrangement.

In accordance with one aspect of the invention, the signal processing unit is configured to perform at least one signal conditioning process selected from the group consisting of gain equalization, bulk dispersion compensation, optical amplification, Raman amplification, dispersion slope compensation, PMD compensation, and load balancing.

In accordance with another aspect of the invention, the optical transmission terminals are selected from terrestrial optical terminals.

In accordance with another aspect of the invention, the gain monitoring arrangement comprises an optical time domain reflectometry arrangement.

In accordance with another aspect of the invention, the optical time domain reflectometry arrangement is a COTDR arrangement.

In accordance with another aspect of the invention, a method is provided for providing optical communication between an undersea optical transmission system that includes an undersea optical transmission path having a plurality of optical repeaters located therealong and a selected one of any of a plurality of different vendor supplied optical transmission terminals each of which has a vendor-specific interface. The method begins by providing signal conditioning to the optical signals received from the selected optical transmission terminal so that the optical signals are suitable for transmission through the undersea optical transmission path. An impaired repeater is identified by determining a change in gain provided by any of the optical repeaters based on an optical signal that is received from the undersea optical transmission path but not communicated to the selected optical transmission terminal. A particular pump source that has failed is identified from among a plurality of pump sources used to supply pump energy to the impaired repeater based on a change in gain determined by the gain monitoring arrangement.

In accordance with another aspect of the invention, in an undersea optical transmission system that includes first and second transmission terminals, an undersea optical transmission path having a plurality of repeater-based optical amplifiers located along the transmission path, and first and second optical interface devices providing optical signal conditioning to communicate optical signals between the undersea transmission path and the first and second terminals, respectively, a method is provided for identifying a failure of a particular pump source from among a plurality of pump sources that collectively supply pump energy to each of the optical amplifiers. The method begins by monitoring an output parameter from each of the plurality of optical amplifiers. Upon failure of a particular one of the plurality of pump sources in a given optical amplifier, a change in the output parameter is identified from the given optical amplifier. Based on the change in the output parameter from the given optical amplifier, the particular one of the plurality of pump sources that has failed is identified.

### BRIEF DESCRIPTION OF THE DRAWINGS

FIG. 1 shows an example of an undersea optical transmission system that employs an optical interface device to provide transparency between the terminal equipment and the wet plant.

FIG. 2 shows one embodiment of a repeater of the type that may be employed in the system depicted in FIG. 1.

### DETAILED DESCRIPTION

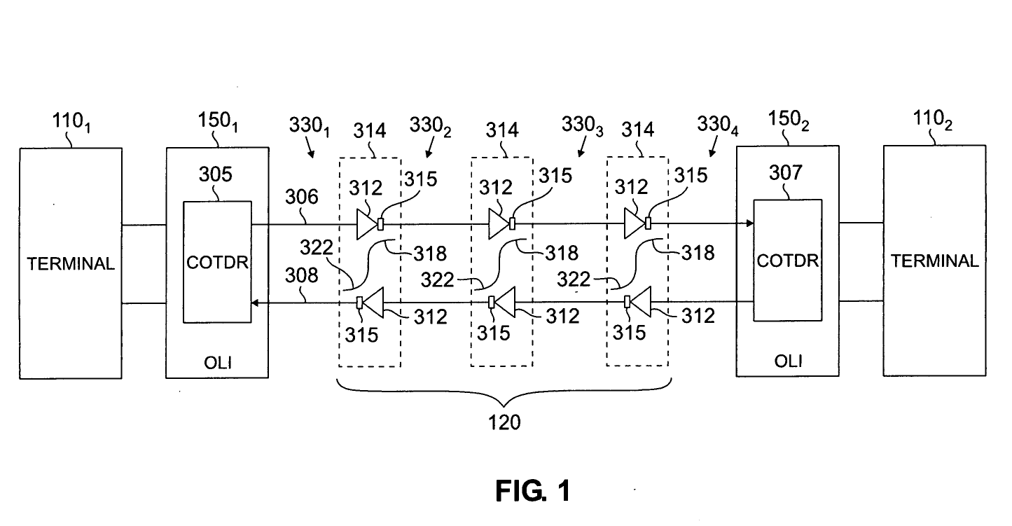

FIG. 1 shows an example of an undersea optical transmission system that employs an optical interface device to provide transparency between the terminal equipment and the wet plant. The system consists of terminal equipment 110₁ and 110₂ that communicate with one another over a wet plant 120 consisting of a pair of unidirectional optical fibers 306 and 308. An optical interface device 150 provides the connectivity between the wet plant 120 and each terminal 110. Specifically, optical interface device 150, provides optical-level connectivity to the vendor specific interface of terminal equipment 110₁ and optical interface device 150₂ provides optical-level connectivity to the vendor specific interface of terminal equipment 110₂. The wet plant 120 and the optical interface devices 150 will generally be provided by a single vendor or system integrator while the terminal equipment 110₁ and 110₂ may be provided by a different vendor. The vendor specific interfaces are usually proprietary interfaces that allow a given vendor to interconnect their optical terminal equipment to one another.

The terminal equipment 110 will typically perform any necessary optical-to-electrical conversion, FEC processing, electrical-to-optical conversion, and optical multiplexing. The terminal equipment 110 may also perform optical amplification, optical monitoring that is designed for the terrestrial optical network, and network protection. Examples of terminal equipment that are currently available and which may be used in connection with the present invention include, but are not limited to, the Nortel LH1600 and LH4000, Siemens MTS 2, Cisco 15808 and the Ciena CoreStream long-haul transport products. The terminal equipment may also be a network router in which Internet routing is accomplished as well as the requisite optical functionality. Moreover, the terminal equipment that is employed may conform to a variety of different protocol standards, such as SONET/SDH ATM and Gigabit Ethernet, for example.

The optical interface device 150 provides the signal conditioning and the additional functionality necessary to transmit the traffic over an undersea optical transmission cable. Examples of suitable interface devices are disclosed in co-pending U.S. patent application Ser. Nos. 10/621,028 and 10/621,115, which are hereby incorporated by reference in their entirety. As discussed in the aforementioned references, the optical interface device receives the optical signals from terminal equipment such as a SONET/SDH transmission terminal either as individual wavelengths on separate fibers or as a WDM signal on a single fiber. The interface device provides the optical layer signal conditioning that is not provided by the SONET/SDH terminals, but which is necessary to transmit the optical signals over the undersea transmission path. The signal conditioning that is provided may include, but is not limited to, gain equalization, bulk dispersion compensation, optical amplification, multiplexing, Raman amplification, dispersion slope compensation, polarization mode dispersion (PMD) compensation, performance monitoring, signal load balancing (e.g., dummy channel insertion), or any combination thereof. The optical interface device also includes line monitoring equipment such as a COTDR arrangement, an autocorrelation arrangement, or other techniques that use in-band or out-of band probe signals to determine the status and health of the transmission path. Additionally, the optical interface device may supply pump power to the transmission path so that Raman amplification can be imparted to the optical signals.

The wet plant 120 includes optical amplifiers 312 that are located along the fibers 306 and 308 to amplify the optical signals as they travel along the transmission path. The optical amplifiers may be rare-earth doped optical amplifiers such as erbium doped fiber amplifiers that use erbium as the gain medium. As indicated in FIG. 1, a pair of rare-earth doped optical amplifiers supporting opposite-traveling signals is often housed in a single unit known as a repeater 314. The transmission path comprising optical fibers 306-308 are segmented into transmission spans 3301-3304, which are concatenated by the repeaters 314. While only three repeaters 314 are depicted in FIG. 1 for clarity of discussion, it should be understood by those skilled in the art that the present invention finds application in transmission paths of all lengths having many additional (or fewer) sets of such repeaters. Optical isolators 315 are located downstream from the optical amplifiers 312 to eliminate backwards propagating light and to eliminate multiple path interference.

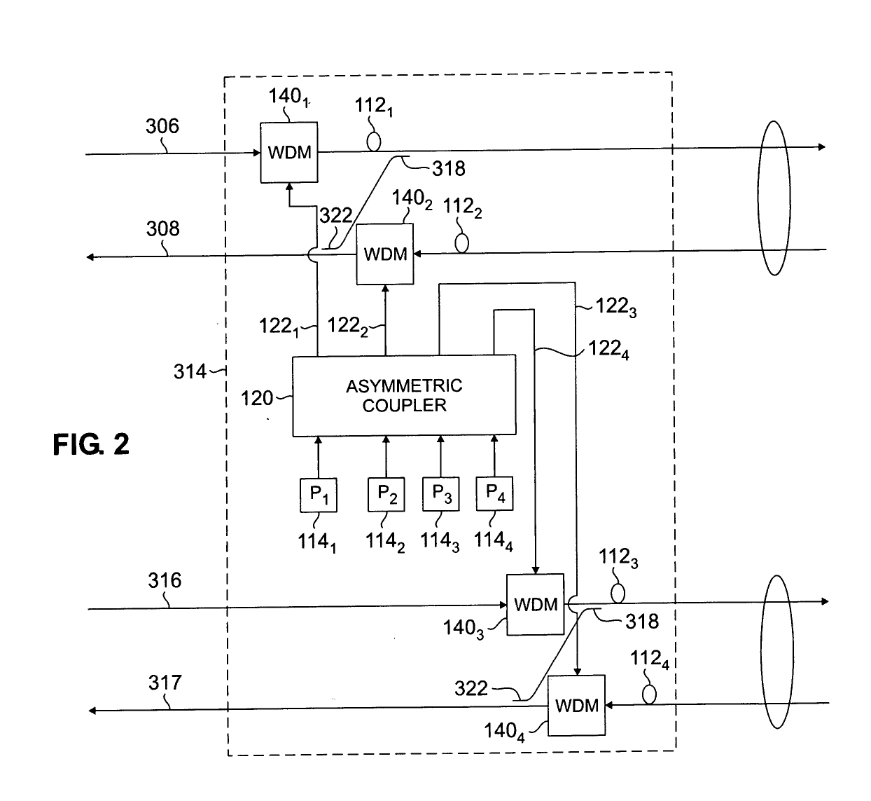

It should be noted that while in FIG. 1 the wet plant 120 comprises a single fiber pair (i.e., fibers 306 and 308), more generally the wet plant 120 may comprise two or more fiber pairs that are located in the same undersea cable. For instance, to fully generalize the present invention, the portion of the wet plant depicted in FIG. 2 (discussed below) includes 2 fiber pairs (i.e., 4 optical fibers). Accordingly, the present invention finds applicability to systems that employ 1 or more fiber pairs.

As previously mentioned, each optical interface device 150₁ and 150₂ may include a COTDR unit 305 and 307, respectively. The COTDR units determine the status and health of the fibers in the various undersea segments 330 of the wet plant 120. The COTDR units generate outgoing probe signals that are used to interrogate the fibers 306 and 308. For example, COTDR unit 305 generates probe signals that interrogate fiber 306 while COTDR unit 307 generates probe signals that interrogate fiber 308.

Each repeater 314 includes a coupler arrangement providing an optical path for use by the COTDR units. In particular, signals generated by reflection and scattering of the probe signal provided by COTDR unit 305 to fiber 306 enter coupler 318 and are coupled onto the opposite-going fiber 308 via coupler 322. The COTDR signal then travels along with the data on optical fiber 308. COTDR 307 operates in a similar manner to generate COTDR signals that are reflected and scattered on fiber 308 so that they are returned to COTDR 307 along optical fiber 306. The signal arriving back at each COTDR is then used to provide information about the loss characteristics of each span.

FIG. 2 shows one embodiment of a repeater 314 of the type that may be employed in the system depicted in FIG. 1. As previously mentioned, in FIG. 2 repeater 314 supports not only the fibers 306 and 308 shown in FIG. 1, but also a second fiber pair comprising fibers 316 and 317. More generally, the present invention encompasses systems and repeaters that support one or more fiber pairs. Each unidirectional optical fiber 306, 308, 316 and 317 includes a rare-earth doped fiber 112₁, 112₂, 112₃, and 112₄, respectively, for imparting gain to the optical signals traveling along the fiber paths. In a transmission system the fiber paths 306, 308, 316 and 317 may be arranged in two pairs (e.g., fibers 306 and 308 comprising one pair and fibers 316 and 317 comprising another pair), each of which support bi-directional communication. Four pump sources 114₁, 114₂, 114₃, and 114₄ supply pump energy to the rare-earth doped fibers 112₁, 112₂, 112₃, and 112₄. A 4×4 asymmetric coupler 120 combines the pump energy generated by the pump sources 114₁, 114₂, 114₃, and 114₄ and splits the combined power among the rare-earth doped fibers 112₁, 112₂, 112₃, and 112₄. Coupling elements 140₁, 140₂, 140₃, and 140₄ respectively receive the pump energy from the output ports 122₁, 122₂, 122₃, and 122₄ of the asymmetric coupler 120 and respectively direct the pump energy onto the fiber paths 306, 308, 316 and 317, where the pump energy is combined with the signals. The coupling elements 140₁, 140₂, 140₃, and 140₄, which may be fused fiber couplers or wavelength division multiplexers, for example, are generally configured to have a high coupling ratio at the pump energy wavelength and a low coupling ratio at the signal wavelength. The pump energy provided to the rare-earth doped fibers 112₁, 112₂, 112₃, and 112₄ is proportional to their gain or output power.

Asymmetric coupler 120 distributes an unequal amount of pump energy from each of the pump sources to the rare-earth doped fibers 112₁, 112₂, 112₃, and 112₄. Because the pump energy is proportional to amplifier gain, the distribution of pump energy is preferably selected so that the failure of any particular pump (or combination of pumps) will give rise to a unique set of values in the gain imparted to the signals by the rare-earth doped fiber 112₁, 112₂, 112₃, and 112₄. That is, for each pump that fails, the amplifier gains collectively change in a way that constitutes a unique pattern or signature that can be used to identify the failed pump. The distribution of pump energy is determined by the coupling ratios between the input and output ports of the asymmetric coupler 120. While the coupling ratios can have any values that satisfy the aforementioned criterion for distributing pump energy, some general considerations will be provided to facilitate their selection and to better illustrate the principals of the invention.

By way of example, assume that the coupling ratios between input ports i and output ports j of asymmetric coupler 120 have a greater value when i=j than when i≠j. That is, the pump energy supplied from pump source 114₁ to doped fiber 112₁ is greater than that supplied from pump source 114₁ to each of the doped fibers 112₂, 112₃, and 112₄. Likewise, the pump energy supplied from pump source 114₂ to doped fiber 112₂ is greater than that supplied from pump source 114₂ to each of the doped fibers 112₁, 112₃, and 112₄. The pump energy supplied from pump sources 114₃ and 114₄ is distributed in a similar manner. Now, assume that pump source 114₁ fails. Since coupler 120 supplies a disproportionate amount of the energy from pump source 114₁ to doped fiber 112₁, as a result of the failure the gain imparted by doped fiber 112₁ will decrease more than the gain imparted by doped fibers 112₂, 112₃, and 112₄. Accordingly, by monitoring the gain arising from each of the doped fibers 112₁, 112₂, 112₃, and 112₄, the change in gain can be used to identify the particular pump that has failed. In a similar manner, if pump source 114₂ fails instead of pump source 114₁, the change in the gain of doped fiber 112₂ will be greater than the gain change of doped fibers 112₁, 112₃, and 112₄. Additional details concerning the use of an asymmetric coupler to identify pump failures may be found in co-pending U.S. patent application Ser. No. 10/417,657, which is hereby incorporated by reference in its entirety.

In order to identify a pump failure using the aforementioned pumping arrangement that employs an asymmetric coupler, an arrangement is required for monitoring the gain of the optical amplifiers along each of the fibers 306, 308, 316 and 317. In general the amplifier gain may be determined by any amplifier gain monitoring means available to those or ordinary skill in the art. One example of a technique that may be used to determine amplifier gain is COTDR. One particular technique for using COTDR to determine the gain (and loss) of the repeaters situated along an optical transmission path is disclosed in co-pending U.S. patent application Ser. No. 11/031,518, which is hereby incorporated by reference in its entirety. More generally, however, any suitable amplifier gain monitoring arrangement may be employed, including optical time domain reflectometry techniques other than COTDR. The gain monitoring means includes a processor for calculating gain changes in the repeaters and for identifying the pump(s) that has failed based on those changes. The processor may be dedicated to the gain monitoring means or it may be a processor that is also used to perform other functionality related to the OLI.

In the present invention, the gain monitoring means may be advantageously located in the OLIs 1501 and 1502. For example, as shown in FIG. 1 OLIs 1501 and 1502 may already include COTDR units 305 and 307, respectively. In this way the OLIs themselves can identify pump failures that arise in the wet plant, thereby eliminating the need to provide this functionality in the terminals 1101 and 1102. By tightly integrating the OLI's with identification of repeater failures in this manner transparency of the wet plant to the terminal equipment is enhanced. If a gain monitoring arrangement other than COTDR is employed, this arrangement can also be incorporated into the OLIs.

1. An optical interface device for use in an undersea optical transmission system that includes an undersea optical transmission path, a plurality of optical repeaters located along the optical transmission path, and a selected one of any of a plurality of different vendor supplied optical transmission terminals each of which has a vendor-specific interface, comprising:
a signal processing unit providing signal conditioning to optical signals received from the vendor-specific interface of the selected optical transmission terminal so that the optical signals are suitable for transmission through the undersea optical transmission path;
a gain monitoring arrangement for determining a change in gain provided by any one of the optical repeaters; and
a processor for identifying a particular pump source that has failed from among a plurality of pump sources used to supply pump energy to said one repeater based on said change in gain determined by the gain monitoring arrangement.

2. The optical interface device of claim 1 wherein the signal processing unit is configured to perform at least one signal conditioning process selected from the group consisting of gain equalization, bulk dispersion compensation, optical amplification, Raman amplification, dispersion slope compensation, PMD compensation, and load balancing.

3. The optical interface of claim 1 wherein said optical transmission terminals are selected from terrestrial optical terminals.

4. The optical interface of claim 1 wherein the gain monitoring arrangement comprises an optical time domain reflectometry arrangement.

5. The optical interface device of claim 4 wherein the optical time domain reflectometry arrangement is a COTDR arrangement.

6. A method for providing optical communication between an undersea optical transmission system that includes an undersea optical transmission path having a plurality of optical repeaters located therealong and a selected one of any of a plurality of different vendor supplied optical transmission terminals each of which has a vendor-specific interface, comprising:
providing signal conditioning to the optical signals received from the selected optical transmission terminal so that the optical signals are suitable for transmission through the undersea optical transmission path;
identifying an impaired repeater by determining a change in gain provided by any of the optical repeaters based on an optical signal that is received from the undersea optical transmission path but not communicated to the selected optical transmission terminal; and
identifying a particular pump source that has failed from among a plurality of pump sources used to supply pump energy to the impaired repeater based on a change in gain determined by the gain monitoring arrangement.

7. The method of claim 6 wherein the signal conditioning includes at least one signal conditioning process selected from the group consisting of gain equalization, bulk dispersion compensation, optical amplification, Raman amplification, dispersion slope compensation, PMD compensation, and load balancing.

8. The method of claim 6 wherein said optical transmission terminals are selected from terrestrial optical terminals.

9. The method of claim 6 wherein the step of identifying an impaired repeater is performed with an optical time domain reflectometry technique

10. The method of claim 9 wherein the optical time domain technique is a COTDR technique.

11. In an undersea optical transmission system that includes first and second transmission terminals, an undersea optical transmission path having a plurality of repeater-based optical amplifiers located along the transmission path, and first and second optical interface devices providing optical signal conditioning to communicate optical signals between the undersea transmission path and the first and second terminals, respectively, a method for identifying a failure of a particular pump source from among a plurality of pump sources that collectively supply pump energy to each of the optical amplifiers, said method comprising the steps of:
monitoring an output parameter from each of the plurality of optical amplifiers;
upon failure of a particular one of the plurality of pump sources in a given optical amplifier, identifying a change in the output parameter from the given optical amplifier; and
based on said change in the output parameter from the given optical amplifier, identifying said particular one of the plurality of pump sources that has failed.

12. The method of claim 11 wherein the monitoring and the identifying steps are performed by the optical interface devices.

13. The method of claim 11 wherein the output parameter is amplifier gain.

14. The method of claim 11 wherein the output parameter is optical output power.

15. The method of claim 11 further comprising the step of distributing the pump energy from the plurality of pump sources to the plurality of optical amplifiers so that the pump energy from each pump source is provided in unequal amounts among at least two of the plurality of optical amplifiers.

16. The method of claim 15 wherein the step of distributing the pump energy is performed by a coupling arrangement.

17. The method of claim 16 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between a given one of the input ports and at least two of the output ports.

18. The method of claim 16 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between each of the plurality of input ports and at least two of the output ports.

19. The method of claim 16 wherein the coupling arrangement comprises a plurality of input ports respectively coupled to the plurality of pump sources and a plurality of output ports respectively coupled to the optical amplifiers, said coupling arrangement being characterized by a coupling ratio between a first of the input ports and a first of the output ports that is greater than the coupling ratio between said first input port and all remaining output ports.

20. The method of claim 19 wherein said coupling arrangement is further characterized by a coupling ratio between a second of the input ports and a second of the plurality of output ports that is greater than the coupling ratio between said second input port and all remaining output ports.
